(19) United States
(12) Patent Application Publication
(10) Pub. No.: US 2007/0195783 A1
(43) Pub. Date: Aug. 23, 2007

(54) Method Of Communicating From A Mobile Device

(76) Inventor: Antoine Faucher, Paris (FR)

Correspondence Address: YOUNG & THOMPSON, 745 SOUTH 23RD STREET, 2ND FLOOR, ARLINGTON, VA, 22202, US

(21) Appl. No.: 10/583,918

(22) PCT Filed: Nov. 3, 2004
(86) PCT No.: PCT/FR04/02822

§ 371 Date: Jan. 3, 2007

(30) Foreign Application Priority Data
Nov. 3, 2003 (FR) 0312871

(51) Int. Cl. H04L 12/56

(52) U.S. Cl. 370/395.2

(57) ABSTRACT

The present invention refers to a process of communication utilizing at least one mobile device comprising means of mobile telecommunications (of GSM, GPRS, UMTS, CDMA, W-CDMA, etc type) and means of access to a local wireless network consisting of: recording user profiles, each bearing a numeric identifier in at least one database of numeric data; sending a first request, said request comprising a plurality of parameters and conveyed by the wireless local network; sending a second request to a server, this request comprising at least one list of identifiers made up of at least one identifier and conveyed via the mobile telephone network; processing the second request at the server level by means of the database comprising the user profiles and getting a response to the second request from the server and displaying this response on a screen of said device. The present invention is also related to a system of communication for utilizing the process comprising a plurality of dual-compatible mobile devices, at least one database, at least one server, and at least one mobile telecommunications network.

The present invention is related to the field of Information and Communication Technologies. More particularly, the present invention relates to a process of communication utilizing at least one mobile device comprising mobile telecommunications means (of GSM, GPRS, UMTS, CDMA, W-CDMA, etc type) and means for accessing to a local wireless network.

The prior art already known, U.S. patent application US2003/0156566 (Doug Griswold and Ron Bexten), relates to a device, processes, and a software product implementing wireless cellular data communications via a wireless local network (W-LAN: Wireless Local Area Network). A system of mobile data communications comprises a wireless cellular data communications network, such as a GPRS or CPDP network, comprising a plurality of base stations that communicate with terminals by means of a first radio interface. The plurality of base stations are coupled to a control node, such as an SGSN (Serving GPRS Support Node) or a CDPD MD-IS (Mobile Data Intermediate System) which administers services, such as invoicing and mobility management, for the terminals that communicate with the base stations. The system also comprises a W-LAN (Wireless Local Area Network), such as a mobile IP network, which may function to communicate with mobile terminals by means of a second radio interface. In addition, the system comprises an “internetworking” system coupled between the control node and the wireless local network (WLAN) which provides data communications between the two. The WLAN may have a coverage area that covers or is associated to a coverage area for a wireless cellular data communications network, such that, for example, data broadband features or high user densities may be supported: “hot spots” such as airports, hotels, conference centers or similar places.

The present invention intends to remedy the inconveniences of the prior art by proposing a very innovative process utilizing the technologies of cellular mobile networks and wireless local networks (like Wifi). The invention finds applications in the dating field, for example.

In that regard, the present invention concerns, in its broadest meaning, a process of communication utilizing at least one mobile device comprising mobile telecommunications means (of GSM, GPRS, UMTS, CDMA, W-CDMA, etc type) and means for accessing to a local wireless network, characterized in that it comprises the steps consisting of:
recording user profiles, each bearing a numeric identifier in at least one database of numeric data;
sending a first request, said request comprising a plurality of parameters and being conveyed by the wireless local network;
sending a second request to a server, this request comprising at least one list of identifiers made up of at least one identifier and conveyed via the mobile telephone network;
processing the second request at the server level by means of the database comprising the user profiles and
obtaining a response to the second request from the server and displaying this response on a screen of said mobile device.

According to a first variant, the two requests are sent in a simultaneous manner.

According to a second variant, the two requests are sent at different times.

According to particular embodiment, the mobile device sends a signal to the local network permanently.

Advantageously, the process comprises, in addition, a step of establishing a list of identifiers corresponding to the responses to the first request.

Preferencially, the process comprises, in addition, a step of sorting through the identifiers corresponding to the responses to the first request.

According to a variant, the sending of the second request is triggered by an action by the user.

According to another variant, the sending of the second request is triggered automatically.

In a particular embodiment, the process is utilized in a dating service.

In another particular embodiment, the process is utilized in a neighborhood vending service.

Advantageously, the process comprises, in addition, a step of converting the identifiers so as to make the identifiers of the telecommunications operator compatible with the identifiers recorded in said database of numeric data.

The present invention is also related to a system of communication for utilizing the process comprising a plurality of dual-compatible mobile devices, at least one database, at least one server, and at least one mobile telecommunications network.

The invention will be better understood with the help of the description, made below purely for purposes of explanation, of an embodiment of the invention, with reference to the appended drawings, in which:

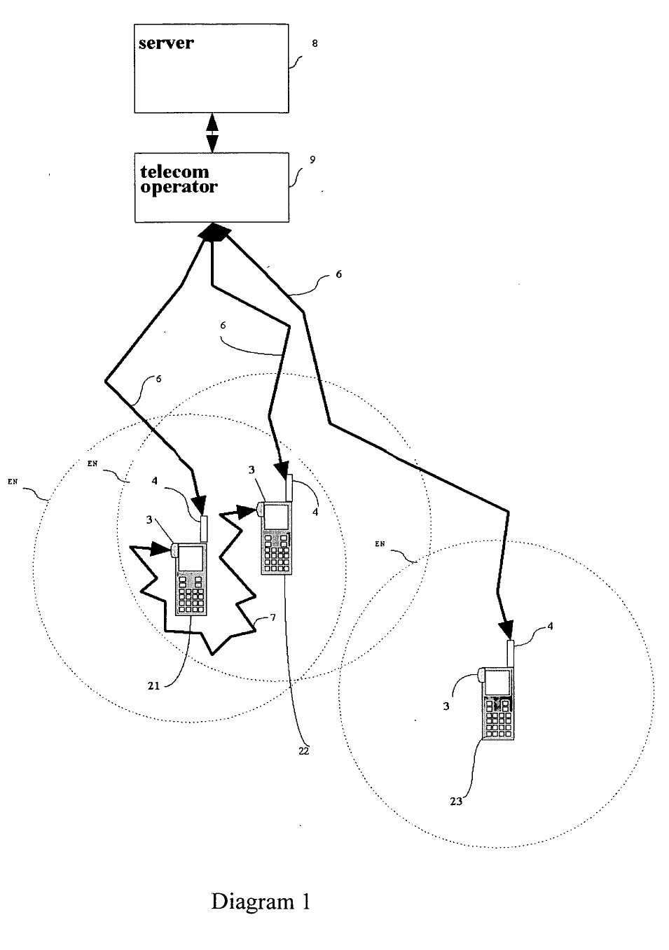

FIG. 1 illustrates a system of transmitting information data between a server and a number of mobile devices according to the present invention;

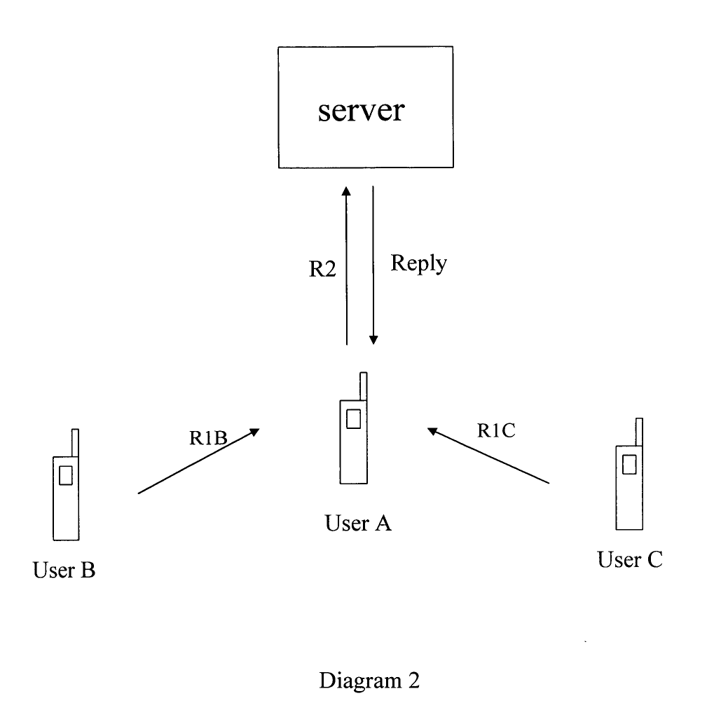

FIG. 2 illustrates a first embodiment of the invention;

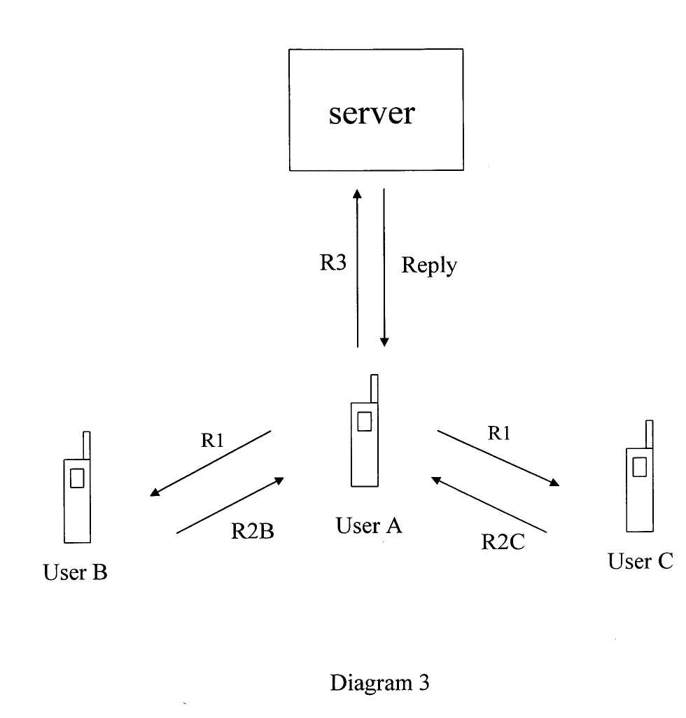

FIG. 3 illustrates a second embodiment of the invention and

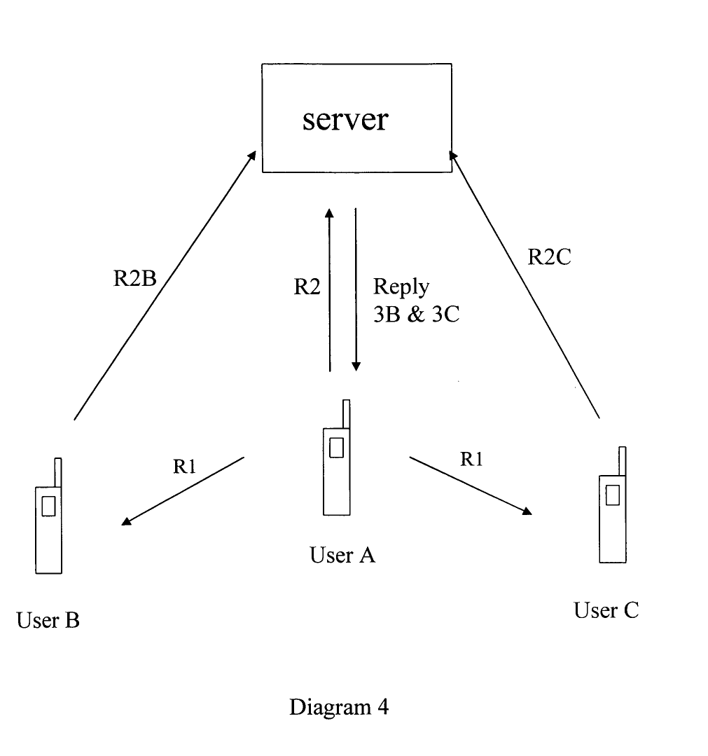

FIG. 4 illustrates a third embodiment of the invention.

It is considered that a user of the present invention must be equipped with a dual-compatible mobile device comprising means of mobile telecommunications (of GSM, GPRS, UMTS, CDMA, W-CDMA, etc type) enabling him/her to access a database of numeric data and means for accessing to a wireless local network enabling him/her to communicate with the other dual-compatible devices in the vicinity. Each user must record a profile in this database of numeric data. Each profile comprises a numeric identifier which shall be unique. In addition to being stored in the database of numeric data, the numeric identifier of the user's profile shall be stored in the user's dual-compatible mobile device.

In the rest of the text, the term “dual-compatible mobile device” is considered to have as a synonym: mobile terminal or mobile device.

Illustrated in FIG. 1, the communication system according to the invention comprises a server 8. The server 8 comprises a database that comprises three tables of data. The first table stores the information that enables the server to know for each user if he/she has the right to use the present invention. This table comprises the following fields:
identifier (Unique key for the table) and
access authorization (yes or no).

The second table stores the information relating to each community. It comprises the following fields:
community name (Unique key for the table);
type of community (Open or Closed) and
list of identifiers that are members of this community.

According to the present invention, “community” will mean a group of users having chosen to exchange certain information among themselves.

In the present invention, any user whatsoever may create a community.

There are two types of community: open communities and closed communities.

In a closed community, an administrator A is the user who has created the community. Having created it, it shall be considered to be his/her community. So that a user B becomes a member of his/her community, administrator A gives user B his/her authorization, without which user B cannot become a member of his/her community even if user B wants to. Administrator A may also exclude members of his/her community.

In an open community, there is no administrator. Each user may, if he/she wants to, become a member of an open community as soon as he/she knows its name.

In this configuration, each user is necessarily a member of “the global community” grouping together all users.

The third table stores the information relating to each user's profile. It comprises the following fields:
identifier (Unique key for the table);
password;
membership list;
list of the names of his/her communities;
identifier information and associated access criteria and
personal information and associated access criteria.

User A's membership list is the list of communities that have user A as a member. The list of names of his/her communities is the list of the names of the closed communities that are administered by the user.

An item of identifier information is an item of information that characterizes an individual's physical appearance. An item of identifier information for an individual may help to identify the individual when he/she is in a crowd. The item of identifier information may indicate the sex, age, height, weight, hair length and color, eye color of a real or imaginary individual or may be an individual's photograph . . .

A user's identifier information is the information that characterizes his/her physical appearance.

User A's personal information is information the user wants to communicate but which is not identifier information. Personal information may tell us the user's nickname, name, tastes, career, idea of an ideal partner, commitment, ideas, humor, address, what he/she wants to sell, what he/she wants to buy, bank balance, bankcard number, etc

By default, user A's identifier information and personal information may be consulted by all other users in the vicinity on their mobile terminal.

But user A may consider that a certain item of identifier or personal information forming part of his/her user profile may not be consulted by all the users in the vicinity. He/she thus considers this information to be sensitive and he/she may therefore limit access to it to only certain users in the vicinity that satisfy certain criteria.

Thus, when user A considers an item of information (identifier or personal) to be sensitive, user A may associate an access criterion to it. The users in the vicinity must satisfy this access criterion in order to be able to consult on their mobile terminal the item of information that user A considered to be sensitive.

An access criterion comprises an identifier criterion or a community criterion:
1) An identifier criterion

An identifier criterion comprises identifier information. A user B satisfies the identifier criterion chosen by user A if user B's identifier information contained in his/her user profile satisfies the identifier criterion chosen by user A.
2) A community criterion

User A's community criterion is a criterion comprising a list of a number of communities chosen by user A. A user B satisfies user A's community criterion if at least one community comprising user A's community criterion is found in user B's membership list.

Any open community whatsoever may be part of the list of communities comprising user A's community criterion. However, only closed communities that have user A as a member may be part of the list of communities comprising user A's community criterion.

The server 8 comprises a connection unit enabling requests to be received that may come from any mobile terminal 2 whatsoever. The connection unit also enables the sending and transmission management of messages intended for one or more mobile terminals.

The server 8 also comprises two processing areas.

The first processing area ensures that the request received may be executed. It makes it possible to prevent fraudulent use of the mobile terminal.

The first processing area systematically consults the first data table and systematically checks that the requestor's identifier is properly authorized to access the server's second and third data tables. This check is essential. If the requester does not have the right to access the data contained in the data tables, the first processing area generates an error message and sends it to the requestor.

If the request passes the first processing area successfully, it passes to the second processing area.

The second processing area determines the type of request and then processes it.

There are two types of request:
the complete request and
the incomplete request.

Only the complete requests may be processed by the second processing area.

There are two formats for the incomplete requests:
type-X requests and
type-Y requests.

A request is complete if it comprises:
the identifier of the initiator of a search;
a search number;
a search criterion and
a list comprising at least one identifier in the vicinity of the initiator of the search.

A search criterion is similar in type to an access criterion. It comprises an identifier criterion and/or a community criterion. But a search criterion is not linked to information contained in the user profiles.

It is linked to a search number and is defined by the user, enabling him/her to obtain more information on all the users in the vicinity who satisfy his/her search criterion.

To avoid any confusion, in the rest of the text, it shall be stated that the access criterion comprises an identifier access criterion and/or a community access criterion and that the search criterion comprises an identifier search criterion and/or a community search criterion.

A request is a type-X request if it comprises:
the identifier of the initiator of a search;
a search number and
a search criterion.

A request is a type-Y request if it comprises:
the identifier of the initiator of a search;
a search number and
one identifier in the vicinity of the initiator of the search.

A type-X request is considered compatible with a type-Y request and vice versa if these two requests comprise the same identifier for the initiator of a search and comprise the same search number.

When a complete request arrives in the second processing area, the second processing area creates a type-X request, which is temporarily stored for about 5 minutes in the server's memory, by means of information contained in the complete request, then the second processing area executes the complete request.

When a type-X request arrives in the second processing area, it is temporarily stored for about five minutes in the server's memory. Then the processing area searches in its memory to see whether there are type-Y requests that are compatible with it. If this is the case, the second processing area transforms each compatible type-Y request into a complete request by means of the type-X request. The second processing area then executes all these complete requests.

When a type-Y request arrives in the second processing area, the second processing area searches in its memory to see whether there is a type-X request that is compatible with it. If this is the case, the second processing area transforms it, by means of the compatible type-X request, into a complete request, which is then executed. If this is not the case, the type-Y request is temporarily stored for about 5 minutes in the server's memory.

Let A be the initiator of a search and B the list of identifiers in the vicinity of the initiator A, then the execution of a complete request occurs as follows:

A first sort step that only retains the identifiers from list B which satisfy user A's search criterion and which are authorized to use the present invention.

A second step that selects, for each identifier comprising the newly-sorted list B, the information from his/her profile which is not linked to access criteria or which is linked to access criteria satisfied by user A's profile.

A third step that comprises sending a response to the user A containing the information selected in the second step.

The system of communication according to the invention also comprises mobile terminals 21, 22, 23, generically called “2”.

Mobile terminal 2 is a portable electronic device providing the technical characteristics of a hand-held computer. It is at least equipped with a screen, a keyboard, a processor, a battery, a hard memory, a random-access memory and an interface connecting up all these elements.

It may be equipped with a slot reserved for inserting a chip storing the identifier that enables the server to identify the user's profile. In this case, before the mobile terminal is first switched on, the user must insert his/her smart card supplied with the mobile terminal into it.

The mobile terminal 2 may store certain information from its profile in its memory.

It also allows its user to enter a search criterion. The user may thus launch a search on his/her mobile terminal. The mobile terminal's interface then creates a new search number and an associated empty list. This empty list associated to its search number will subsequently comprise the identifiers in the vicinity that have been picked up.

The interface then stores these three elements in the mobile terminal's memory:
the search number created;
the previously entered search criterion and
the associated empty list.

The mobile terminal 2 also comprises a connection unit 3 enabling access to the wireless local network with regard to communicating with the other dual-compatible devices in the vicinity.

The connection unit 3 may send requests intended for other mobile terminals in a surrounding area EN, by radio-communication, via a radio link 7.

The connection unit 3 may receive requests sent from other mobile terminals located in a surrounding area EN, by radio-communication, via a radio link 7.

The connection unit 3 may for example be according to WIFI communication standards.

The mobile terminal 2 also comprises another connection unit 4 enabling communication to be established by a radio link 6 with the telecommunications operator 9. The connection unit 4 may for example be according to GPRS or UMTS communications standards.

The mobile telecommunications operator 9 is linked permanently to the server 8 by means of a broadband link 5. The connection unit 4 may therefore communicate with the server 8 by means of the telecommunications operator 9.

Thus, by means of its connection unit 4, the mobile terminal may send requests to the server 8 and receive the server's response to its request. The mobile terminal may also receive a message coming from the server, this message not being preceded by a request.

But, in a more general manner, a mobile terminal may indirectly send a request to the server through one or more other mobile terminals in the vicinity.

The mobile terminal 2 comprises a processing area.

On a command from the mobile terminal's interface, the processing area may generate new requests which are then sent by the connection unit 3 or 4.

In addition, the mobile terminal's processing zone permanently analyzes the requests that are picked up by its connection unit 3. The processing area may decide to generate a new request after having analyzed a picked-up request; this request is then sent by the connection unit 3 or 4.

The mobile terminal's connection unit 3 may pick up two types of requests:
type-M requests sent by the initiator of a search and
type-P requests sent by a user in the vicinity of the initiator of a search.

The type-M request may possibly comprise the identifier of the initiator of a search and a search number.

If the type-M request comprises the identifier of the initiator of a search and a search number, the request may possibly comprise in addition a search criterion.

The type-P request comprises the identifier of the person who sent it. It may also possibly comprise the identifier of the initiator of a search and a search number.

When the connection unit 3 receives a type-M request that does not comprise a search criterion, the processing area automatically generates a new type-P request.

When the connection unit 3 receives a type-M request comprising a search criterion, the processing area determines whether it must generate a new type-P request. The processing area thus consults its memory and determines whether it can find out if its user satisfies the search criterion contained in the type-M request. If its user does not satisfy the search criterion, the processing area does not generate a new type-P request. If the processing area does not know whether its user satisfies the search criterion, or if its user satisfies the search criterion, the processing area generates a new type-P request.

If the type-M request received does not comprise the identifier of the initiator of a search or a search number, the new type-P request is necessarily sent to the other mobile terminals in the vicinity by means of the connection unit 3.

If the type-M request received comprises the identifier of the initiator of a search and a search number, and if the processing area generates a new type-P request, the new type-P request necessarily comprises the identifier of the initiator of a search and a search number contained in the type-M request received, and is sent either to the other mobile terminals in the vicinity by means of the connection unit 3 or is sent to the server by means of the connection unit 4.

It is noted that this new type-P request sent to the server may then be called a type-Y incomplete request.

Lastly, on a command from the interface, the processing area may generate then send a new type-P request (not following on from a type-M request); in this case, this new type-P request is sent to the other mobile terminals in the vicinity by means of the connection unit 3 and comprises neither the identifier of the initiator of a search not a search number.

When the connection unit receives a type-P request, the processing area first of all makes sure that the type-P request is addressed to it. It is addressed to it if the received request does not comprise the identifier of the initiator of a search or if the identifier of the initiator of a request contained in the received request corresponds to the identifier of the user of the mobile terminal having received this request.

If it is addressed to the mobile terminal and the type-P request does not contain any search number, then the processing area adds the identifier of the mobile terminal that sent the type-P request to all the lists associated to the search numbers present in the mobile terminal's memory.

If it is addressed to the mobile terminal and the type-P request contains a search number that is the same as one of the search numbers present in its memory, the processing area adds the identifier of the mobile terminal that sent the type-P request to its associated list.

If the user had previously initiated a search, the interface may tell the processing area to generate a new complete request to be sent to the server comprising the identifier of its user, his/her search number, his/her associated search criterion, and the associated list of identifiers picked up; these latter three elements are then deleted from the mobile terminal's memory.

The invention then allows the user to obtain on his/her mobile terminal information about the users in the vicinity that satisfy the search criterion he/she had previously selected; the mobile terminal's interface may display on the latter's screen any information whatsoever stored or processed by its processing area or contained in any request whatsoever picked up by its connection unit 3 or 4.

We are now going to describe below three embodiments of the present invention used by three people: A, B and C. It is understood that these three examples may in no way be limiting.

According to the first embodiment, the connection unit 3 of each user's mobile device has the characteristic of permanently sending a type-P request comprising the identifier of its user intended for other mobile devices in the vicinity. This transmission takes place at a random moment in a five-second interval every five seconds.

This sending process allows the receiver process to minimize the risk of collision between two radio signals leading to the loss of the two items of information. In effect, even if two mobile devices send their identifiers at the same time, the probability that they will again send at the same time five seconds later is very slight. Because of this, the receiver of the connection unit 3 has a strong probability of picking up all the identifiers in the vicinity in a thirty-second period.

Thus, the mobile device does not need to send a type-M request to the other mobile devices in the vicinity so that they send a type-P request comprising their identifier, signaling their presence. In order to update the lists of identifiers in the vicinity that have been picked up, it just needs its processing area to analyze the type-P requests over a 30-second period.

According to the first embodiment, illustrated in FIG. 2, user A enters a search criterion on his/her mobile device. Then he/she launches a search. User A is thus the initiator of a search.

The interface for A's mobile device creates a new search number and an empty associated list. The interface then stores this search number, its associated empty list and the previously entered search criterion on the mobile device's memory.

The connection unit 3 of B's mobile device permanently sends a type-P request R1B comprising B's identifier, intended for other mobile devices in the vicinity.

The connection unit 3 of C's mobile device permanently sends a type-P request R1C comprising C's identifier, intended for other mobile devices in the vicinity.

The connection unit of A's mobile device receives the type-P requests R1B and R1C comprising B's identifier and C's identifier respectively.

The processing area of A's mobile device then analyses the requests R1B and R1C and concludes that these requests were properly addressed to it because they do not comprise the identifier of the initiator of a search. The processing area adds B's identifier and C's identifier to the empty list created previously.

On a command from the interface of A's mobile device, the processing area generates a new complete request R2 comprising A's identifier, the previously created search number and its associated list comprising the identifiers of B and C and the search criterion previously entered by A.

The complete request R2 is then sent to the server. After having successfully passed the server's first processing area, the complete request R2 is performed by the server's second processing area.

In a first step, the server consults its tables of data; it concludes that users B and C satisfy user A's search criterion.

In a second step, the server selects the information contained in the profile for user B and user C which user A can access.

In a third step, the server sends the information previously selected by the server to user A.

A's mobile device receives the data coming from the server and this is displayed on the screen.

Henceforth, in the second and third embodiments, it will be considered that, in addition to being stored on the server, each user's identifier information is also stored in the memory of their mobile devices. Moreover, it is considered that the type-M requests comprise the identifier search criterion.

According to a second embodiment, illustrated in FIG. 3, user A enters a search criterion (comprising an identifier search criterion and a community search criterion) on his/her mobile device. Then he/she launches a search. User A is thus the initiator of a search.

The interface for A's mobile device creates a new search number and an empty associated list. The interface then stores this search number, its associated empty list and the previously entered search criterion on the mobile device's memory.

On a command from the interface, the processing area generates a type-M request R1 comprising A's identifier, the previously created search number and the search criterion previously entered. Once generated, the type-M request R1 is sent to the mobile devices in the vicinity.

Once received, the processing area of mobile devices B and C in the vicinity analyses the type-M request R1 and concludes that their user satisfies user A's search criterion.

The processing area of B's and C's mobile devices then generates a type-P request comprising A's identifier, the search number identical to the search number in the request R1 and B's identifier for processing area of B's mobile device and C's identifier for processing area of C's mobile device respectively. Once generated, the requests R2B and R2C are sent to the mobile devices in the vicinity and are intended for A's mobile device.

Once received, the processing area of A's mobile device processes the two requests R2B and R2C.

These requests have been sent to it because the identifier of the initiator of a search in the requests R2B and R2C is A's identifier.

The processing area then adds B's and C's identifiers into the empty list previously created.

On a command from the interface of A's mobile device, the processing area generates a new complete request R3 comprising A's identifier, the previously created search number and its associated list comprising the identifiers of B and C and the search criterion previously entered by A.

The complete request R3 is then sent to the server. After having successfully passed the server's first processing area, the request R3 is performed by the server's second processing area.

In a first step, the server consults its tables of data and it concludes that only user B satisfies user A's community search criterion.

In a second step, the server selects the information contained in the profile for user B which user A can access.

In a third step, the server sends the information previously selected by the server to user A.

A's mobile device receives the data coming from the server and this is displayed on the screen.

In a variant of the second embodiment, it is envisaged that user C's identifier information do not satisfy user A's identifier search criterion. In this case, after having received request R1, the processing area of C's mobile device does not generate a new request. A's mobile device only receives the request R2B and then sends a complete request R3 to the server comprising A's identifier, the previously created search number and its associated list comprising only B's identifier and the search criterion previously entered.

According to a third embodiment, illustrated in FIG. 4, user A enters a search criterion (comprising an identifier search criterion and a community search criterion) on his/her mobile device. Then he/she launches a search. User A is thus the initiator of a search.

The interface for A's mobile device creates a new search number and an empty associated list. The interface then stores this search number, its associated empty list and the previously entered search criterion on the mobile device's memory.

On a command from the interface, the processing area generates a type-X incomplete request R2 comprising A's identifier, the previously created search number and the search criterion previously entered. Once generated, the type-X request R2 is sent to the server.

On a command from the interface, the processing area generates a type-M request R1 comprising A's identifier, the previously created search number and the search criterion previously entered. Once generated, the type-M request R1 is sent to the mobile devices in the vicinity.

Once received, the processing area of the mobile devices B and C in the vicinity analyzes the type-M request R1 and concludes that their user satisfies user A's identifier search criterion.

The processing area of B's and C's mobile devices then generates a type-P request comprising user A's identifier, the search number identical to the search number in the request R1 and B's identifier for processing area of B's mobile device and C's identifier for processing area of C's mobile device respectively. Once generated, the requests R2B and R2C are sent to the server.

It is noted that these new requests R2B and R2C are also type-Y incomplete requests.

After having successfully passed the server's first processing area, the server's second processing area processes the request R2, R2B and R2C.

The server then creates two complete requests by associating the type-X request R2 with the type-Y request R2B, and the type-X request R2 with the type-Y request R2C. The server performs these two new complete requests.

The server sends the response 3B and 3C to user A's mobile device.

The choice between the first embodiment, the second embodiment and the third embodiment may result from an optimization of the characteristics of the mobile telecommunications network and the local wireless network.

Thus, if the local wireless network is overloaded, the mobile device will favor a dialogue with the server rather than with the other mobile devices in the vicinity like in the first embodiment. On the other hand, if the server is overloaded, the second embodiment will be favored, with prior processing at the level of the mobile terminals.

The present invention, according to any embodiment whatsoever, may be used for a large number of types of application depending on the characteristics of the searches and the information stored in the user profiles.

The user may, for example, search a crowd for people with a specified age (with, for examples, requests of the type “age under 30”) or with specified leisure activities (for example, “loves reading” or “enjoys Japanese films”).

In addition, in the purchasing or selling field, the user can search a crowd of sellers (in a market, for example) for the one offering the lowest prices, or the one selling a specific product.

The invention is described above by way of example. It is understood that the people in the technical field are able to realize different embodiments without in any way leaving the scope of the patent.

1-12. (canceled)

13. A process of communication using at least one mobile device comprising means for communicating via a mobile telephone network and means for accessing to a local wireless network, comprising:
a step of recording users' profiles, each having an identifier in at least one database;
a step of sending a first request comprising a plurality of parameters and being conveyed by the local wireless network;
a step of sending a second request to a server, the second request comprising at least one identifier and being conveyed via the mobile telephone network;
a step of processing the second request by the server by means of a database comprising the users' profiles; and
a step of getting a response to the second request from the server and displaying this response on a screen of said mobile device.

14. The process of claim 13, wherein the two requests are sent simultaneously by the mobile device.

15. The process of claim 13, wherein the second requests is sent after at least one response to the first request is received from another mobile device, through the local wireless network, and includes at least one identifier received in one response to the first request.

16. The process of claims 13, wherein the mobile device sends a signal to the local wireless network permanently.

17. The process of claim 13, further comprising a step of constituting a list of identifiers corresponding to responses to the first request.

18. The process of claim 17, further comprising a step of selecting among the identifiers corresponding to the responses to the first request.

19. The process of claim 13, wherein the sending of the second request is initiated by an action from the user.

20. The process of claim 13, wherein the sending of the second request is initiated automatically.

21. The process of claim 13, that is used in a dating service.

22. The process of claim 13, that is utilized in a neighborhood vending service.

23. The process of claim 13, further comprising a step of identifier conversion in order to make telecommunications operator's identifiers compatible with the identifiers recorded in said database comprising the users' profiles.

24. A system of communication comprising at least one mobile device comprising means for communicating via a mobile telephone network and means for accessing to a local wireless network, at least one remote database comprising users' profiles, each having an identifier and a server, wherein at least one mobile device is adapted to send, through the local wireless network, a first request comprising a plurality of parameters, to send a second request to the server via the mobile telephone network, the second request comprising at least one identifier, wherein the server is adapted to process the second request by making use of the database comprising the users' profiles and to send to said mobile device, a response to the second request, said mobile device being adapted to display the response to the second request on a screen of said mobile device.

25. The system of claim 24, wherein the mobile device is adapted to send the two requests simultaneously.

26. The system of claim 24, wherein the mobile device is adapted to send the second requests after at least one response to the first request is received from another mobile device, through the local wireless network, the second request including at least one identifier received in one response to the first request.

27. The system of claims 24, wherein the mobile device is adapted to send a signal to the local wireless network permanently.

28. The system of claim 24, wherein the mobile device is adapted to constitute a list of identifiers corresponding to responses to the first request.

29. The system of claim 28, wherein the mobile device is adapted to select among the identifiers corresponding to the responses to the first request to constitute the list of identifiers.

30. The system of claim 24, wherein the mobile device is adapted to send the second request upon an action from the user.

31. The system of claim 24, wherein the mobile device is adapted to automatically send the second request.

32. The system of claim 24, wherein the server is adapted to convert identifiers to make telecommunications operator's identifiers compatible with the identifiers recorded in said database comprising the users' profiles.
